(19) United States
(12) Patent Application Publication
(10) Pub. No.: US 2006/0207927 A1
(43) Pub. Date: Sep. 21, 2006

(54) Garnet filtration system for use with water jet cutting tools

(76) Inventor: Edward L. Tirakian, Algonac, MI (US)

Correspondence Address: HARNESS, DICKEY & PIERCE, P.L.C., P.O. BOX 828, BLOOMFIELD HILLS, MI, 48303, US

(21) Appl. No.: 11/384,925

(22) Filed: Mar. 17, 2006

Related U.S. Application Data
(60) Provisional application No. 60/663,440, filed on Mar. 18, 2005.

(51) Int. Cl. B01D 36/00

(52) U.S. Cl. 210/416.1

(57) ABSTRACT

A garnet filtration system for use with water jet cutting tools is described. The filtration system includes a pump with a fluid collection housing in addition to a pump housing containing an impeller with the drive shaft running through an opening in the pump housing and through the fluid collection housing. A bushing disposed in the pump housing around the drive shaft restricts but does not prevent seepage of fluid between the bushing and the drive shaft into the fluid collection housing. A pipe connected to the fluid collection housing drains the fluid to a catch tank for re-circulating. Alternatively, the fluid is directed to a waste treatment drain. Fluid pumped out of the pump housing is directed to a centrifugal separator for separation of a garnet particulate from a water-based slurry.

### CROSS-REFERENCE TO RELATED APPLICATIONS

This application claims the benefit of U.S. Provisional Application No. 60/663,440, filed on Mar. 18, 2005. The disclosure of the above application is incorporated herein by reference.

### FIELD OF THE INVENTION

The present invention relates to abrasive particulate centrifugal filtration systems for use with water jet cutting tools and more particularly to such systems using a sealless pump.

### BACKGROUND OF THE INVENTION

Water jet tools producing high pressure jets of water containing abrasive particles are used to cut a variety of materials including metals, stone, ceramics, concrete, tile and glass. A water jet tool connects a high pressure water pump to a cutting head in order to produce an ultra-high pressure water jet for discharge through a water jet nozzle. Before the water jet is discharged an abrasive particulate such as garnet particles are added to facilitate the cutting of the material. The water jet containing the abrasive particulate is ejected through the water jet nozzle onto a workpiece that is restrained on a cutting table. As the water jet containing the abrasive particulate passes through the workpiece it is collected in a catch tank below. An option in the industry is to “sweep” the bottom of the catch tank by directing a flow of the water and particulate slurry into a centrifugal filtration system. The centrifugal filtration system separates out the particulate from the water by pumping the particulate slurry through a centrifugal separator. A catch basin collects the used particulate. The separated water substantially relieved of the particulate may be disposed of or re-circulated into the catch tank to repeat the process of sweeping the particulate slurry into the centrifugal filtration system. Due to the abrasive character of the particulate the water and particulate slurry is abrasive and damaging to the particulate filtration system. In particular, the pump used to draw the particulate slurry through the filtration system is subject to frequent breakdown and to damage caused by the particulate especially in areas around seals of the pump. A review of prior art particulate filtration systems for use with water jet cutting tools demonstrates this point.

Referring to FIG. 1, an example of a prior art particulate filtration system for a water jet tool is illustrated. In FIG. 1, a water jet tool 10 receives high pressure water through a high pressure water hose 12 connected between the water jet tool 10 and an ultra high pressure water pump (not shown). Attached to the water jet tool is a cutting head 14 for directing a flow of the water onto the workpiece 16 below. A second hose 18 is attached to the cutting head 14 or water jet tool for injecting an abrasive particulate such as garnet into the high pressure water jet stream 17.

The workpiece 16 is retained on a work table 20 that allows for passage of the spent water and particulate spray 22 into a catch tank 24 below. Water 26 fills the catch tank 24 with the particulate 28 accumulating on the bottom.

In order to relieve the catch tank 24 from the water 26 and particulate 28 slurry a pump 30 with an impeller 32 directs a flow 34 of the water 26 and particulate 28 slurry into the pump 30. An electric motor 36 rotates the impeller 32 at the end of a drive shaft 38. The water 26 and particulate 28 slurry is forced in a flow direction 40 leading out of the pump 30. The water 26 and particulate 28 slurry while inside of the pump causes damage to the components, most particularly the impeller 32 and seals 42 of the pump 30. Due to the abrasive nature of the water 26 and particulate 28 slurry the seals 42 of the pump 30 fail on an unpredictably but frequent basis. After the flow of the water 26 and particulate 28 leaves the pump 30 it is directed towards a centrifugal separator 44. The separator 44 causes the water 26 and particulate 28 slurry to spin within the separator 44 in a spin direction 46. This causes the particulate 28 to separate from the water 26 through the effect of centrifugal force. In the separator 44 a deflector 48 causes the water 26 to form a vortex and travel back up the center of the separator 44 where it is drawn in a direction 50 out of the separator 44. The water 26 now substantially clean of the particulate 28 may be re-circulated in a direction 52 back into the catch tank 24 in order to direct the flow of the particulate 28 at the bottom of the catch tank 24 in a direction towards the inlet 54 of the pump 30. The particulate 28 that is drawn out of the water 26 through the separator 44 is collected in a container 56 below the separator 44.

Due to the high and consistent failure rate for the seals 42 around the drive shaft 38 of the pump 30 this prior art system caused frequent down time for the water jet cutting tool since it is required to continually remove the particulate and water slurry that accumulates in the catch tank. As illustrated in FIG. 2, in a variation of the prior art system, the pump 60 does not have a seal as in the first prior art system. Water 26 and particulate 28 are able to escape through a clearance 62 between the drive shaft 64 and the pump 60 housing. This relieved the need for frequent replacement of the drive shaft pump seals 42 (of FIG. 1) but at the same time created an additional problem as it was necessary to have in place a second catch tank 66 to collect the water 26 and particulate 28 that escaped around the shaft 64 of the pump 60. The requirement of a second catch tank 66 made the entire filtration system bulky and added additional cost in providing a second catch tank 66. Further, it is necessary to remove the water 26 and particulate 28 that collected in the second catch tank 66. This is complicated by the settling of the particulate out of the water at the bottom of the second catch tank 66. The additional space requirements and maintenance costs of this second prior art system are burdensome.

Therefore, there is a need for a cost effective filtration system that will not require a second catch tank but will allow for long and stable operation of the filtration system in this inherently corrosive environment.

### SUMMARY OF THE INVENTION

The present invention is directed to a garnet filtration system that provides a solution to the aforementioned problems associated with other filtration systems. The present invention features a garnet filtration system for use with water jet cutting tools. The garnet filtration system comprises a pump having a shaft with an impeller attached on one end and an electric motor attached on the other end for rotating the impeller. The pump shaft passes through an opening in a housing of the pump. A bushing is disposed in the pump housing leaving a gap between the shaft and the bushing. Thus, a fluid and particulate slurry is allowed to seep from the interior of the pump through the space between the bushing and the shaft of the pump. A second housing of the pump is on top of the pump housing and allows for the shaft of the pump to pass therethrough. Slurry that bypasses the bushing surrounding the shaft of the pump is allowed to collect in the space created by the second housing. An opening in the second housing allows for the movement of any slurry that accumulates in the second housing away from the pump. In an embodiment a pipe connected to the second housing directs the slurry that collects in the second housing to a catch tank used to collect slurry from the water jet tool. This pipe is interconnected to an overflow pipe connected from a discharge hopper to allow both the discharge hopper overflow and the slurry to flow to the catch tank. In a second embodiment a pipe connected to the second housing leads only to the catch tank. In a third embodiment a pipe connected to the second housing directs slurry from the second housing to a drain. The pump is also connected to a centrifugal separator for separating the particulate from the fluid.

Thus, the invention advantageously provides for a cost effective efficient system that is resilient to the harsh environment of the abrasive particulate slurry. By removing a seal between the pump shaft and housing a critical point of failure is removed thus eliminating substantial down time and significant equipment repair costs. Instead, the invention advantageously provides a second housing for collection and distribution of fluid that seeps into the second housing. Further, the invention provides significant advantage over the alternative system using an open container to collect fluid that seeped out of the pump housing. Since the invention eliminates the need for this container, there is no need to de-sludge, maintain and provide space for such a container.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is diagram of a prior art filtration system for a water jet cutting tool;

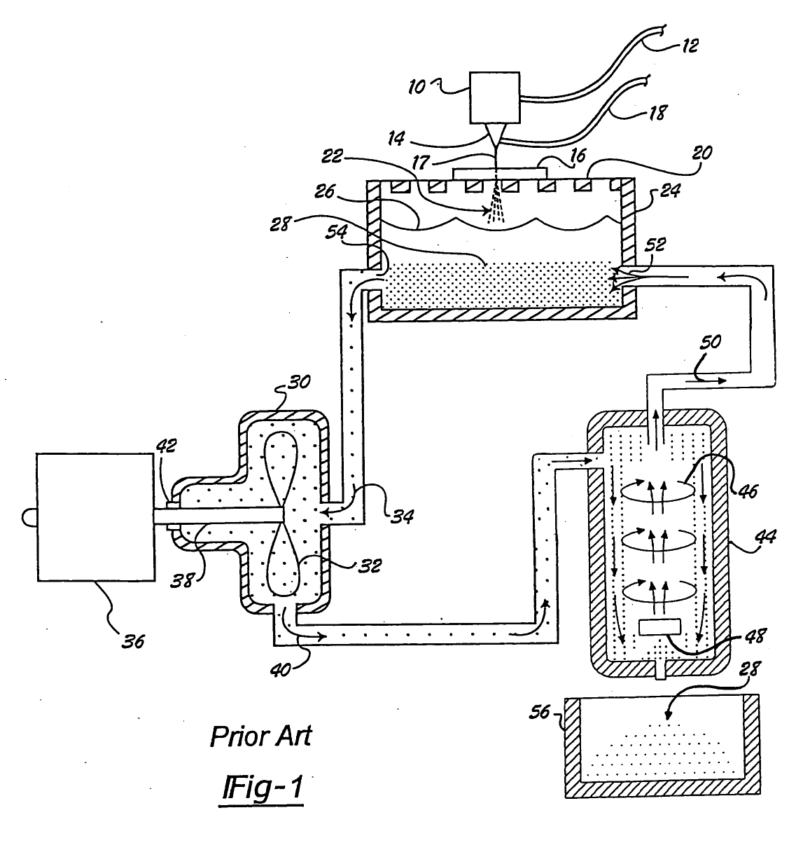

FIG. 2 is a second prior art filtration system;

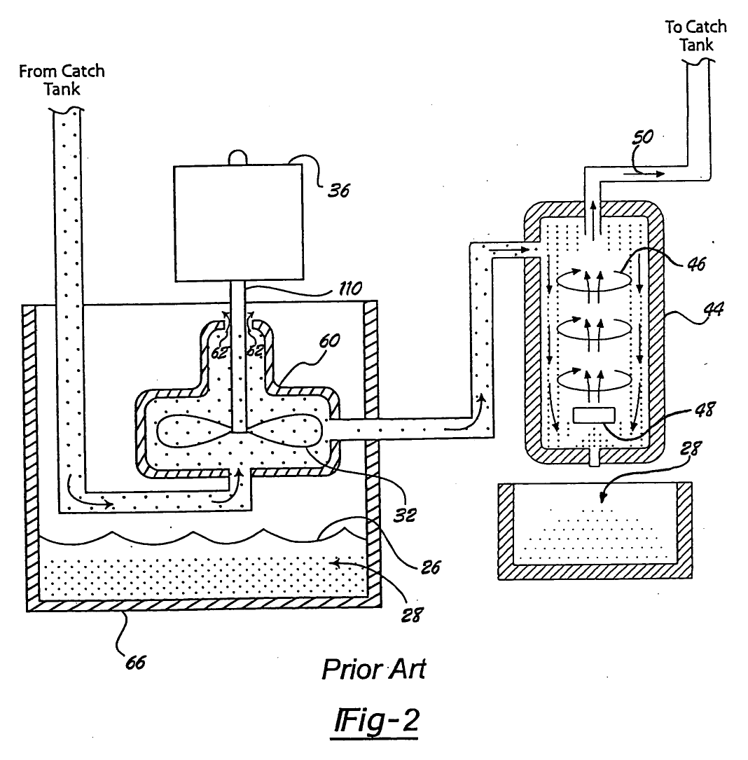

FIG. 3 is a front plan view of an embodiment of the garnet filtration system of the present invention;

FIG. 4 is a side plan view of the embodiment of the present invention as shown in FIG. 3;

FIG. 5 is a cross-sectional view of the pump of the embodiment of the present invention as shown in FIG. 4;

FIG. 6 is a front plan view of a second embodiment of the present invention; and

FIG. 7 is a front plan view of a third embodiment of the present invention.

### DETAILED DESCRIPTION OF THE PREFERRED EMBODIMENTS

The following description of the preferred embodiments is merely exemplary in nature and is in no way intended to limit the invention, its application, or uses.

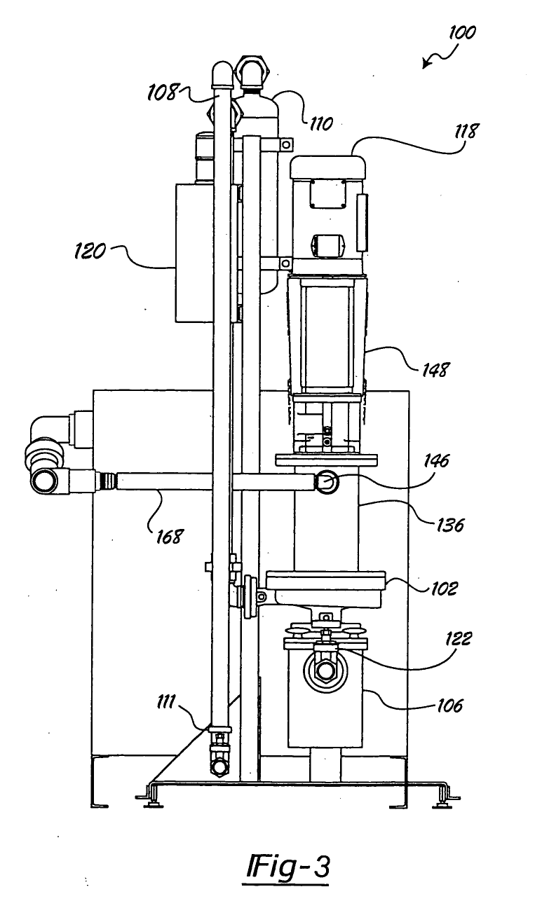

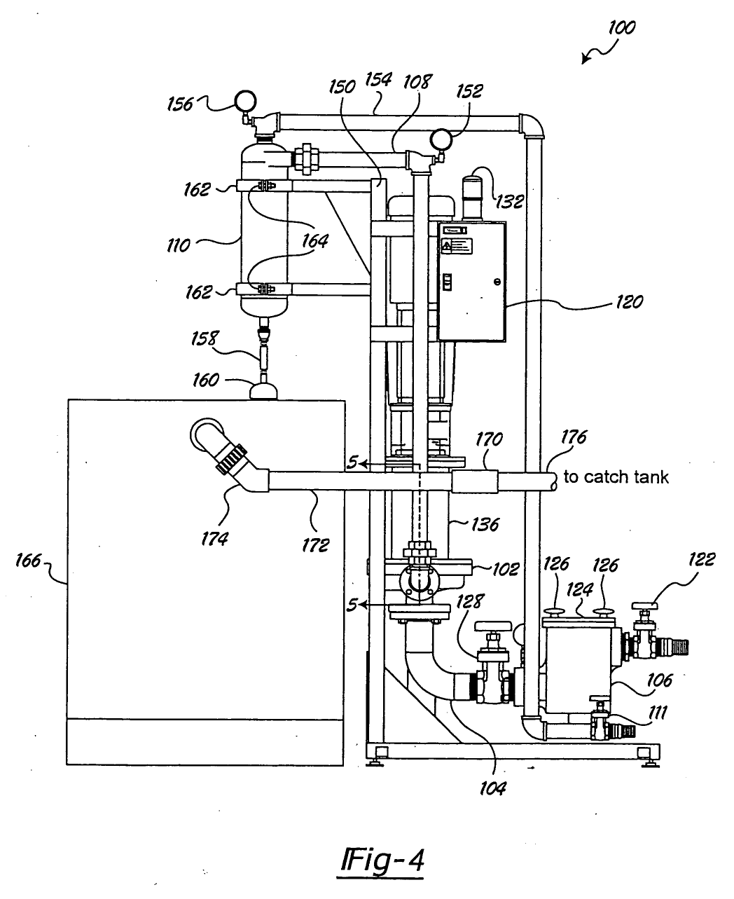

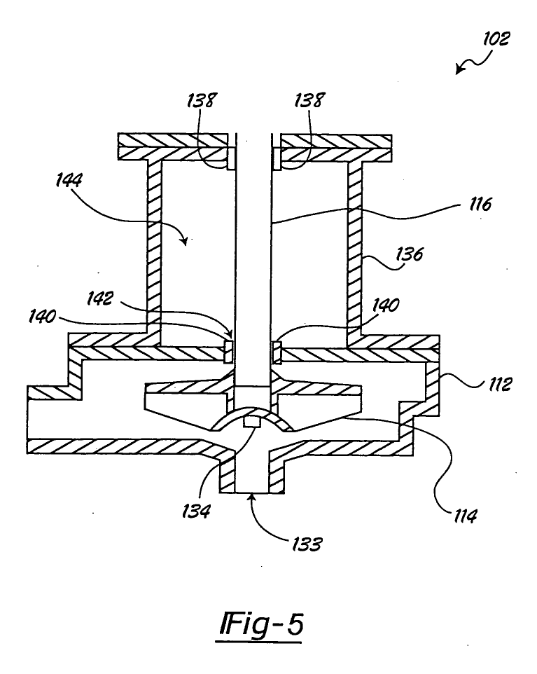

Referring to FIGS. 3-5, an embodiment of the filtration system of the present invention is shown. The filtration system 100 features a pump 102 connected via an inlet pipe 104 to a strainer basket 106. The pump 102 is also connected via an outlet pipe 108 to a centrifugal separator 110. The centrifugal separator is connected via a return valve 111 to a catch tank (not shown) for a water jet cutting tool. An exemplary catch tank and water jet cutting tool are disclosed in U.S. Pat. No. 6,077,162 incorporated herein by reference.

The pump 102 has a pump housing 112. Within the pump housing 112 an impeller 114 is connected to a drive shaft 116. The drive shaft is connected to an electric motor 118. A power box 120 connected by wires (not shown) to the electric motor 118 supplies electric current to the electric motor 118.

The strainer basket 106 is connected to a system inlet valve 122 for receiving a fluid slurry mix of water and garnet. The strainer basket contains a large bore filter (not shown) for removal of large particle debris, for example, metal particles of 0.25 inches diameter or larger. The strainer basket 106 filter is accessed through a top side portal 124 held in place by two latches 126. A second inlet valve 128 is connected between the strainer basket 106 and the inlet pipe 104. A first pressure gauge 130 is connected between the second inlet valve 128 and the strainer basket 106. The first pressure gauge 130 provides a suction pressure measure of the flow of fluid through the strainer basket 106 filter. The first pressure gauge 130 is connected to an alarm system with a signal light 132 mounted on top of the power box 120 for warning of the event of the strainer basket 106 filter being occluded by waste to the extent that overall system pressure reaches a system damaging level.

The pump housing 112 has a pump intake 133 connected to the inlet pipe 104. A locking nut 134 connects the impeller 114 to the drive shaft 116 within the pump housing 112. The drive shaft 116 passes through an opening in the pump housing 112 into a fluid collection housing 136. The drive shaft 116 exits the fluid collection housing 136 through an opening in the fluid collection housing 136 located distally from the impeller 114. A seal 138 prevents fluid from leaking out of this opening. Bushing 140 is disposed within the pump housing 112 proximally to the impeller 114. The bushing 140 provides a circumferential gap 142 between the drive shaft 116 and the bushing 140. Advantageously the bushing 140 does not seal against the drive shaft 116 thus allowing a seepage of fluid into a fluid collection space 144 of the fluid collection housing 136. The gap 142 between the bushing 140 and the drive shaft 116 is approximately 0.005 inches. A portal 146 allows fluid to exit the fluid collection housing 136.

The electric motor 118 is spaced apart from the fluid collection housing 136 by a motor shroud 148. A support frame 150 holds in place the electric motor 118, the pump housing 112, the centrifugal separator 110, and the strainer basket 106 of the filtration system 100.

The electric motor 118 is preferably a 230/460 volt AC three phase motor at a speed of 1,750 RPM. However, any suitable motor will suffice. The size of the motor will depend upon the amount of fluid intended to be circulated through the filtration system 100 within a given time period.

The centrifugal separator 110 is substantially tubular in shape and receives the outlet pipe 108 tangentially near its top cover. Commercially available separators are suitable for performing the function of the centrifugal separator 110. Preferably, the centrifugal separator 110 contains internal slotting where the inlet pipe 108 connects tangentially to the centrifugal separator 110 to prevent internal damage as a result of dead spots allowing the water and garnet slurry to abrade the internal structure of the separator. A second pressure gauge connected to the inlet pipe 108 allows for measuring the pressure of fluid entering the centrifugal separator 110. The centrifugal separator 110 is connected to a return pipe 154 having a third pressure gauge 156 for measuring the pressure of a fluid exiting the centrifugal separator 110. The centrifugal separator 110 is connected to a disposal tube 158 that is in turn connected to a purge diffuser 160. Beneath the centrifugal separator 110 a discharge hopper 166 is situated to collect spent garnet. The centrifugal separator 110 is held in place on the support frame 150 by brackets 162 and bracket screws 164.

The portal 146 of the fluid collection housing 136 connects to a collection pipe 168 for directing the flow of fluid within the fluid collection space 144 within the fluid collection housing 136 to a T-pipe 170 connected to the collection pipe 168. A catch tank pipe 176 connected to the T-pipe 170 directs the flow of fluid into the catch tank (not shown) used to collect fluid from the water jet tool. A second collection pipe 172 leads from the T-pipe 170 to an elbow pipe 174 that in turn is connected to the discharge hopper 166 for collecting any overflow fluid in the discharge hopper 166.

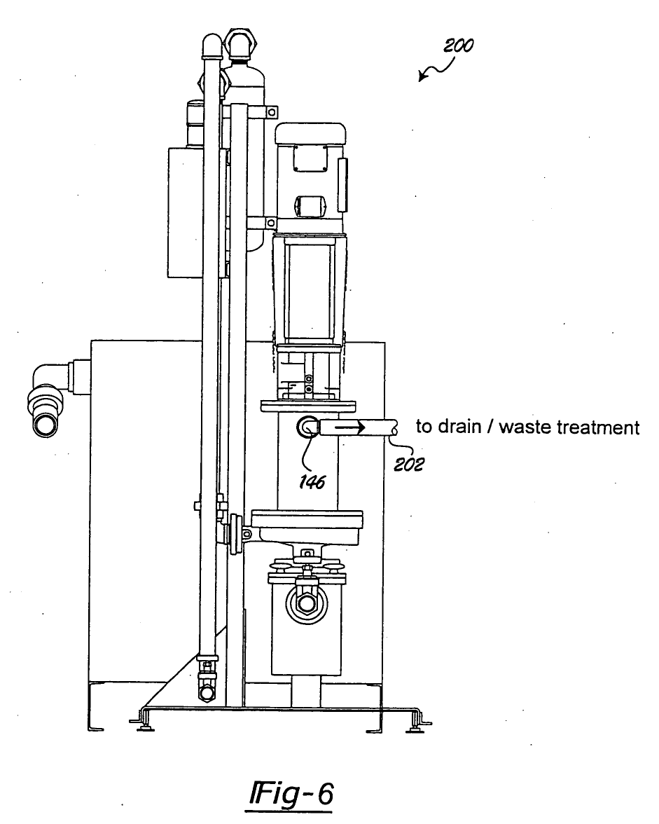

Now referring to FIG. 6 in a second embodiment an alternative filtration system 200 features a disposal drain 202 connected to the portal 146 for directing a flow of fluid to a drain/waste treatment area (not shown).

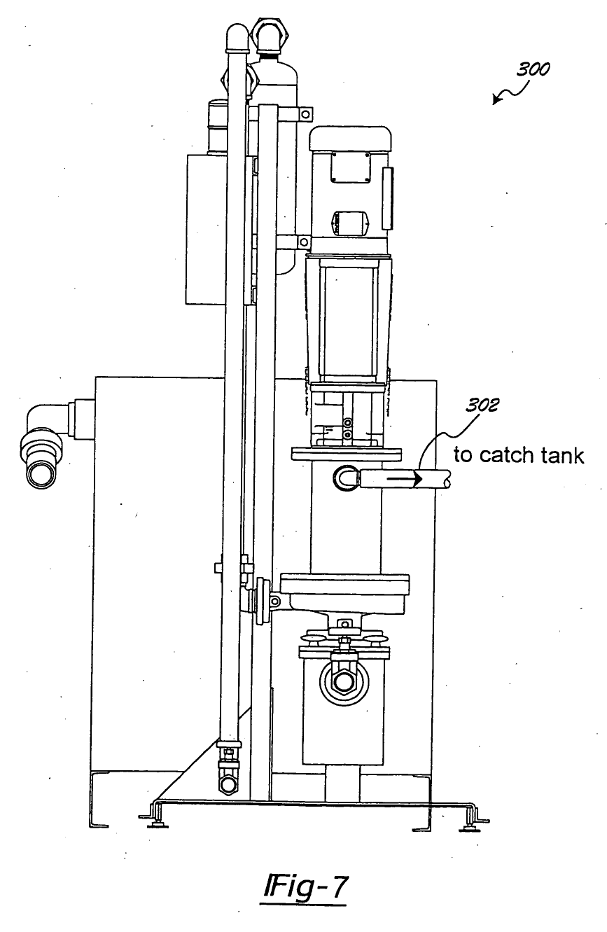

Referring to FIG. 7 in a third embodiment a filtration system 300 features a return pipe 302 connected directly to the catcher tank.

In operation, the electric motor 118 is energized thus turning the drive shaft 116 of the pump 102. The impeller 114 is rotated drawing the water and garnet slurry through a system inlet valve 122 into the strainer basket 106. The filter in the strainer basket advantageously allows for retention of large particles while allowing free flow of the garnet and water slurry through the second inlet valve 128 and through the inlet pipe 104 into the pump housing 112. Centrifugal action of the impeller 114 forces the water and garnet slurry into the outlet pipe 108 towards the centrifugal separator 110.

As the water and garnet slurry is forced into the outlet pipe 108 it also to a limited extent seeps through the gap 142 between the bushing 140 and the drive shaft 116 into the fluid collection space 144 of the fluid collection housing 136. Advantageously this feature protects the filtration system 100 by eliminating a seal in the area of the bushing 140 that is a frequent failure point. Further, as the bushing 140 receives wear due to the corrosive character of the water and garnet slurry, the gap 142 will widen but will not result in system failure since advantageously the fluid that collects in the fluid collection space 144 is re-circulated in the system. The water and garnet slurry that collects in the fluid collection space 144 is gravity fed to the catch tank. This allows for timed maintenance of the bushings 140 due to an increase of flow of water and garnet slurry into the fluid collection space 144 rather than a critical breakdown and work stoppage.

The water and garnet slurry that is forced by the pump 102 into the outlet pipe 108 enters the centrifugal separator 110 where the garnet is substantially separated from the water. The spent garnet is directed through the disposal tube 158 into the discharge hopper 166. The filtered water leaving the centrifugal separator 110 is directed to the return pipe 154 where it is returned to the catch tank (not shown) for sweeping the catch tank and/or to a drain for waste disposal.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A particulate filtration system for a water jet cutting tool comprising:
a pump having a first housing for drawing a fluid containing an abrasive particulate into the first housing and pumping the fluid out of the first housing into a separator wherein the first housing has an opening for a drive shaft connected between an impeller and a motor wherein the opening is not sealed around the drive shaft thus allowing the fluid to enter a second housing distally of the impeller; and
a drainage opening in the second housing for draining the fluid from the second housing.

2. The particulate filtration system of claim 1, wherein a bushing is positioned between the first housing and the second housing.

3. The particulate filtration system of claim 1, wherein the drainage opening from said second housing is coupled to a conduit which directs the fluid to a catch tank.

4. The particulate filtration system of claim 3, wherein the conduit coupled to said drainage opening from said second housing joins a drain from a discharge hopper, wherein overflow fluid from said discharge hopper and said second housing are directed to a catch tank.

5. The particulate filtration system of claim 1, wherein the drainage opening from said second housing is coupled to a conduit which directs the fluid to a drain.

6. The particulate filtration system of claim 1, wherein the drainage opening from said second housing is coupled to a conduit which directs the fluid to a waste treatment facility.

7. The particulate filtration system of claim 2, wherein the bushing is serviceable.

8. The particulate filtration system of claim 3, wherein fluid from said second housing is gravity fed through said drainage opening.

9. The particulate filtration system of claim 4, wherein fluid from said second housing is gravity fed through said drainage opening.

10. The particulate filtration system of claim 5, wherein fluid from said second housing is gravity fed through said drainage opening.

11. The particulate filtration system of claim 6, wherein fluid from said second housing is gravity fed through said drainage opening.

12. The particulate filtration system of claim 3, wherein a serviceable bushing is positioned between the first housing and the second housing.

13. The particulate filtration system of claim 4, wherein a serviceable bushing is positioned between the first housing and the second housing.

14. The particulate filtration system of claim 5, wherein a serviceable bushing is positioned between the first housing and the second housing.

15. The particulate filtration system of claim 6, wherein a serviceable bushing is positioned between the first housing and the second housing.
